(19) United States
(12) Patent Application Publication
(10) Pub. No.: US 2024/0047750 A1
(43) Pub. Date: Feb. 8, 2024

(54) NONAQUEOUS ELECTROLYTE, SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Norio TAKAMI, Yokohama (JP); Tomoko SUGIZAKI, Kawasaki (JP); Keigo HOSHINA, Yokohama (JP)

(73) Assignee: KABUSHIKI KAISHA TOSHIBA, Tokyo (JP)

(21) Appl. No.: 18/171,407

(22) Filed: Feb. 20, 2023

(30) Foreign Application Priority Data
Jul. 26, 2022 (JP) 2022-118955

(51) Int. Cl. H01M 10/0568

(52) U.S. Cl. CPC H01M 10/0568; H01M 2220/20; H01M 2220/10; H01M 2300/0025

(57) ABSTRACT

In general, according to one embodiment, an ionic liquid is provided. The ionic liquid includes a cation including a trialkylsulfonium ion and a lithium ion. The ionic liquid further includes an anion including at least one of [N(FSO₂)₂]⁻ or [N(CF₃SO₂)₂]⁻. A molar ratio between the lithium ion and the trialkylsulfonium ion is in a range of 1:4 to 4:1. A molar ratio between [N(FSO₂)₂]⁻ and [N(CF₃SO₂)₂]⁻ is in a range of 4.2:1 to 1:0.

### CROSS-REFERENCE TO RELATED APPLICATION

This application is based upon and claims the benefit of priority from Japanese Patent Application No. 2022-118955, filed Jul. 26, 2022, the entire contents of which are incorporated herein by reference.

### FIELD

Embodiments relate to a nonaqueous electrolyte, a secondary battery, a battery pack, a vehicle, and a stationary power supply.

### BACKGROUND

A nonaqueous electrolyte battery using lithium metal, a lithium alloy, a lithium compound, or a carbonaceous material for a negative electrode is expected as a high energy density battery, and is actively researched and developed. Thus far, lithium ion batteries including a positive electrode containing LiCoO₂ or LiMn₂O₄ as an active material and a negative electrode containing a carbonaceous material that has lithium ions to be inserted and extracted have been widely put to practical use for portable devices. In order to advance application to electric vehicles and stationary storage batteries, in addition to increases in energy density and capacity of secondary batteries, improvements in durable life performance, low-temperature performance, and safety are required. In order to increase the energy density of a secondary battery, research and development have been made on a battery including a metal negative electrode (for example, Li, Na, Mg, or Al), a battery including a sulfur-containing positive electrode, or a battery using an air electrode as a positive electrode as a post-lithium ion battery; but it is difficult to achieve both high energy density and durable life performance.

In a battery including a metal negative electrode, if Li metal is used for the metal negative electrode, there is a problem such as a short circuit due to dendrite deposition, and if Mg metal is used for the metal negative electrode, overvoltage is large, and there is a problem that the charge-discharge cycle is difficult. On the other hand, these days, since an ionic liquid at room temperature containing cations and anions has non-volatility, incombustibility, and non-flammability, high safety can be expected. Therefore, the ionic liquid has been studied as an electrolytic solution of a lithium secondary battery using a Li metal negative electrode. However, since the ionic liquid is reductively decomposed, cycle deterioration of the secondary battery is large, and it is difficult to put a battery including the ionic liquid into practical use.

### BRIEF DESCRIPTION OF THE DRAWINGS

FIG. 1 is a cross-sectional view schematically showing an example of a secondary battery according to an embodiment.

FIG. 2 is an enlarged cross-sectional view of part A of the secondary battery shown in FIG. 1.

FIG. 3 is a partially cutaway perspective view schematically showing another example of the secondary battery according to the embodiment.

FIG. 4 is an enlarged cross-sectional view of part B of the secondary battery shown in FIG. 3.

FIG. 5 is an exploded perspective view schematically showing an example of a battery pack according to the embodiment.

FIG. 6 is a block diagram showing an example of an electric circuit of the battery pack shown in FIG. 5.

FIG. 7 is a cross-sectional view schematically showing an example of a vehicle according to the embodiment.

FIG. 8 is a block diagram showing an example of a system including a stationary power supply according to the embodiment.

### DETAILED DESCRIPTION

In general, according to one embodiment, an ionic liquid is provided. The ionic liquid includes a cation including a trialkylsulfonium ion and a lithium ion. The ionic liquid further includes an anion including at least one of [N(FSO₂)₂]⁻ or [N(CF₃SO₂)₂]⁻. A molar ratio between the lithium ion and the trialkylsulfonium ion is in a range of 1:4 to 4:1. A molar ratio between [N(FSO₂)₂]⁻ and [N(CF₃SO₂)₂]⁻ is in a range of 4.2:1 to 1:0.

According to another embodiment, a secondary battery is provided. The secondary battery includes a positive electrode, a negative electrode, and the nonaqueous electrolyte according to the embodiment.

According to another embodiment, a battery pack is provided. The battery pack includes the secondary battery according to the embodiment.

According to another embodiment, a vehicle is provided. The vehicle includes the battery pack according to the embodiment.

According to another embodiment, a stationary power supply is provided. The stationary power supply includes the battery pack according to the embodiment.

### First Embodiment

According to a first embodiment, there is provided a nonaqueous electrolyte containing an ionic liquid containing cations including a trialkylsulfonium ion and a lithium ion and anions including at least one of [N(FSO₂)₂]⁻ or [N(CF₃SO₂)₂]⁻. The molar ratio between lithium ions and trialkylsulfonium ions is in the range of 1:4 to 4:1, and the molar ratio between [N(FSO₂)₂]⁻ and [N(CF₃SO₂)₂]⁻ is in the range of 4.2:1 to 1:0. However, in a case where the anion component includes [N(FSO₂)₂]⁻ and [N(CF₃SO₂)₂]⁻, the range of the molar ratio between [N(FSO₂)₂]⁻ and [N(CF₃SO₂)₂]⁻ is 4.2:1 to 1:0 (excluding 1:0). [N(FSO₂)₂]⁻ and [N(CF₃SO₂)₂]⁻ are abbreviated as FSI and TFSI, respectively. The ionic liquid may contain a cation and an anion.

The nonaqueous electrolyte of the first embodiment can be used for, for example, a secondary battery. The FSI anion may form a protective film on the surface of the negative electrode, for example, a negative electrode current collector. An example of the protective film is a protective film containing F and/or S. In a case where the negative electrode current collector contains Al, a protective film containing aluminum fluoride can be generated. Therefore, the FSI anion can suppress reductive decomposition of the nonaqueous electrolyte. On the other hand, the TFSI anion is excellent in electrochemical stability at a high temperature and at a high voltage. In addition, since the size of the TFSI anion is different from that of the FSI anion, the presence of both the FSI anion and the TFSI anion increases the disorder of the structure, and makes it possible to stably maintain the supercooled state without solidification or crystallization even at a low temperature of −50° C. or less. By setting the molar ratio between FSI anions and TFSI anions to be in the range of 4.2:1 to 1:0, a protective film can be formed on the negative electrode, so that reductive decomposition of the nonaqueous electrolyte can be suppressed. In addition, oxidative decomposition of the ionic liquid in the positive electrode in high voltage charging can be suppressed. For example, corrosion of the current collector due to an anion that may be present as an impurity in an ionic liquid or the like, such as a chloride ion, can be suppressed. Further, metals such as nickel, cobalt, and manganese can be dissolved from the positive electrode in a high-temperature environment. Therefore, since oxidative decomposition and reductive decomposition of the nonaqueous electrolyte can be suppressed, cycle life performance at a high temperature (for example, 45° C. or more) can be improved. In addition, the presence of the TFSI anion in addition to the FSI anion in the nonaqueous electrolyte makes it possible to maintain a liquid state in a wide temperature range from a high temperature (200° C.) to a low temperature (−50° C. or less) to exhibit ion conductivity. Therefore, by the molar ratio between [N(FSO₂)₂]⁻ and [N(CF₃SO₂)₂]⁻ being in the range of 4.2:1 to 1:0, the secondary battery can improve discharge rate performance in addition to high-temperature cycle life performance.

The preferred range of the molar ratio between FSI anions and TFSI anions varies depending on the temperature at which the nonaqueous electrolyte is used.

In a case where the temperature at which the nonaqueous electrolyte is used is 20° C. or more and 80° C. or less, a preferred range of the molar ratio between FSI anions and TFSI anions is 9:1 to 1:0. Thereby, the suppression of reductive decomposition of the nonaqueous electrolyte at a high temperature can be enhanced, so that the high-temperature durability performance of the nonaqueous electrolyte can be enhanced.

In a case where the temperature at which the nonaqueous electrolyte is used is −50° C. or more and 20° C. or less, a preferred range of the molar ratio between FSI anions and TFSI anions is 4.2:1 to 9:1. Thereby, the ion conductivity of the nonaqueous electrolyte can be enhanced, so that the low-temperature performance of the nonaqueous electrolyte can be improved.

Here, the temperature at which the nonaqueous electrolyte is used is the operating temperature of the battery. The operating temperature of the battery is, for example, the temperature of the battery itself during use.

The trialkylsulfonium ion of the cation has a skeleton represented by the following Chem. 1 and is paired with an anion. Examples of the anion include the FSI anion and the TFSI anion.

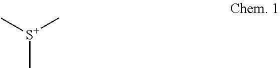

The molar ratio between lithium ions and trialkylsulfonium ions can be in the range of 1:4 to 4:1. Within this range, a liquid state can be maintained at around normal temperature while the lithium ion concentration of the nonaqueous electrolyte is increased. Examples of the trialkylsulfonium ion include a trimethylsulfonium ion (S(CH₃)₃⁺: an abbreviation is S111), a triethylsulfonium ion (S(C₂H₅)₃+: an abbreviation is S222), a diethylpropylsulfonium ion (S(C₂H₅)₂(C₃H₇)⁺: an abbreviation is S223), a methylethylpropylsulfonium ion (S(CH₃)(C₂H₅)(C₃H₇)⁺: an abbreviation is S123), and the like. A preferred example is a triethylsulfonium ion (S222). By the ionic liquid containing the cation of S222, the melting point of the ionic liquid is lowered, and the ion conductivity is increased. In addition, by the ionic liquid containing the cation of S222, the electrochemical window of the nonaqueous electrolyte is widened, so that a high voltage secondary battery can be operated. One kind or two or more kinds of trialkylsulfonium ions can be used. The molar ratio between lithium ions and trialkylsulfonium ions is more preferably in the range of 1:3 to 2:1. Within this range, the charge transfer resistance at the negative electrode interface can be reduced, so that discharge performance and cycle life performance can be improved in the secondary battery.

By setting the molar ratio between lithium ions and trialkylsulfonium ions to be in the range of 1:4 to 4:1 and setting the molar ratio between FSI anions and TFSI anions to be in the range of 4.2:1 to 1:0, oxidative decomposition and reductive decomposition of the nonaqueous electrolyte can be suppressed, so that cycle life performance at a high temperature of, for example, 45° C. or more can be improved. In addition, since the ion conductivity of the nonaqueous electrolyte is excellent, the discharge rate performance can be improved.

The lithium ion of the cation can be supplied from, for example, a lithium salt. As the lithium salt, LiN(FSO₂)₂ and LiN(CF₃SO₂)₂ are preferable. One kind or two or more kinds of lithium salts can be used. The amount of the lithium salt dissolved in the ionic liquid is preferably 0.3 mol/kg or more and 3 mol/kg or less. Within this range, the interface resistance of the negative electrode such as a negative electrode including metallic lithium can be reduced, so that improvement of large current characteristics, suppression of dendrite deposition, and improvement of cycle life performance can be achieved. LiN(FSO₂)₂ and LiN(CF₃SO₂)₂ are abbreviated as LiFSI and LiTFSI, respectively.

The nonaqueous electrolyte may contain an organic fluorine compound (organic fluoride). Thus, the formation of a protective film on the negative electrode can be promoted. In addition, the viscosity of the nonaqueous electrolyte can be reduced to increase the ion conductivity. Since the TFSI anion can be reductively decomposed by the negative electrode (for example, lithium metal (Li) negative electrode) in a high temperature environment, there is a concern that the resistance of the film on the negative electrode will be increased and the charge-and-discharge cycle life will be reduced. If the organic fluorine compound is incorporated into the nonaqueous electrolyte and the content of the organic fluorine compound in the nonaqueous electrolyte is set to 0.1 wt % or more and 10 wt % or less, a low-resistance artificial protective film containing fluorine can be formed on the surface of the negative electrode. Since this protective film can suppress the growth of a high-resistance covering containing sulfur, charge-discharge at a large current density or reductive decomposition of the TFSI anion in a high-temperature environment can be suppressed, and reduction of interface resistance and improvement of cycle life performance can be achieved. In addition, since the nonaqueous electrolyte containing the organic fluorine compound can reduce overvoltage in the positive electrode having a high voltage of 4 V or more (vs. Li/Li⁺), the cycle life performance can be improved. Furthermore, since the amount of the lithium salt dissolved in the ionic liquid can be increased to increase the lithium ion concentration of the nonaqueous electrolyte, overvoltage can be reduced. The lower limit of the content of the organic fluorine compound in the nonaqueous electrolyte can be 0.5 wt % or 1 wt %. The upper limit of the content can be 5 wt %. By setting the content of the organic fluorine compound in the nonaqueous electrolyte to 1 wt % or more and 5 wt % or less, the viscosity of the nonaqueous electrolyte can be reduced, so that low-temperature performance can be improved.

Examples of the organic fluorine compound include a fluorinated ester, a fluorinated ether, and the like. Examples of the fluorinated ester include fluoroethylene carbonate (FEC), difluoroethylene carbonate (DFEC), 2,2,2-trifluoroethyl methyl carbonate (TFEMC), and the like. Examples of the fluorinated ether include 1,1,2,2-tetrafluoroethyl 2,2,2-trifluoroethyl ether (HFE) and the like.

Examples of other organic fluorine compounds (organic fluorides) include methyl 3,3,3-trifluoropropionate (FMP), 2,2,2-trifluoroethyl acetate (FEA), and the like. Any of the organic fluorine compounds can reduce the viscosity of the nonaqueous electrolyte. One kind or two or more kinds of organic fluorine compounds can be used.

The nonaqueous electrolyte may contain particles of a lithium ion conductive solid electrolyte. Thereby, ion conductivity at a low temperature can be improved. The lithium ion conductive solid electrolyte preferably has a lithium ion conductivity at 25° C. of 1×10⁻⁴ S/cm or more, more preferably 1×10⁻³ S/cm or more.

Examples of the lithium ion conductive solid electrolyte include an oxide solid electrolyte having a garnet-type structure, a lithium phosphate solid electrolyte having a NASICON-type structure, and the like.

The oxide solid electrolyte having a garnet-type structure has advantages of high reduction resistance and a wide electrochemical window. Examples of the oxide solid electrolyte having a garnet-type structure and a lithium ion conductivity at 25° C. of 1×10⁻³ S/cm or more include La₅₊ₓAₓLa₃₋ₓM₂O₁₂ (A is one or more selected from the group consisting of Ca, Sr, and Ba, M is one or more selected from the group consisting of Nb and Ta, 0≤x≤0.5), Li₃M₂₋ₓL₂O₁₂ (M is one or more selected from the group consisting of Ta and Nb, L may include Zr, 0≤x≤0.5), Li₇₋₃ₓAlₓLa₃Zr₃O₁₂ (0≤x≤0.5), and Li₇La₃Zr₂O₁₂. Li_{6.25}Al_{0.25}La₃Zr₃O₁₂ and Li₇La₃Zr₂O₁₂ each have high ion conductivity and stable electrochemical properties, and therefore can provide a secondary battery excellent in discharge performance and cycle life performance.

The specific surface area of the oxide solid electrolyte particles having a garnet-type structure can be in the range of 10 m²/g or more and 100 m²/g or less. Thereby, the chemical stability of the solid electrolyte to the ionic liquid can be enhanced.

The size (diameter) of the oxide solid electrolyte particle having a garnet-type structure can be in the range of 0.01 μm or more and 0.5 μm or less. Within this range, the ion conductivity of the nonaqueous electrolyte can be increased, so that discharge performance and low-temperature performance can be improved. A more preferred range is 0.05 μm or more and 0.3 μm or less.

Examples of the lithium phosphate solid electrolyte having a NASICON-type structure and a lithium ion conductivity at 25° C. of 1×10⁻⁴ S/cm or more include a substance represented by LiM₂(PO₄)₃ (M is one or more selected from the group consisting of Si, Ti, Ge, Sr, Zr, Sn, Al, and Ca). A substance represented by Li_{1+y}AlₓM₂₋ₓ(PO₄)₃ (M is one or more selected from the group consisting of Si, Ti, Ge, Sr, Zr, and Ca, 0≤x≤1, 0≤y≤1) is preferable. Li₁₋ₓAlₓGe₂₋ₓ(PO₄)₃ (0≤x≤0.5, 0≤y≤1), Li_{1+z}AlₓZr₂₋ₓ(PO₄)₃ (0≤x≤0.5), and Li_{1+z}AlₓTi₂₋ₓ(PO₄)₃ (0≤x≤0.5) are preferable because they have high ion conductivity and high electrochemical stability.

The specific surface area of the lithium phosphate solid electrolyte particles having a NaSICON-type structure can be in the range of 10 m²/g or more and 100 m²/g or less. Thereby, the chemical stability of the solid electrolyte to the ionic liquid can be enhanced.

The size (diameter) of the lithium phosphate solid electrolyte particle having a NaSICON-type structure can be in the range of 0.01 μm or more and 1 μm or less. Within this range, the ion conductivity of the nonaqueous electrolyte can be increased, so that discharge performance and low-temperature performance can be improved. A more preferred range is 0.05 μm or more and 0.6 μm or less.

The solid electrolyte may contain inevitable impurities other than those listed above. One kind or two or more kinds of solid electrolytes can be used.

The nonaqueous electrolyte is desirably in contact with the positive electrode and the negative electrode, or contained or held in the positive electrode, the negative electrode, and the separator. This makes it possible to smoothly produce a charge-discharge reaction.

The nonaqueous electrolyte is desirably in a liquid state or a gel state. The gel nonaqueous electrolyte is obtained by, for example, adding a polymer material and a gelling agent to an ionic liquid to form a gel.

A method for identifying the component of the nonaqueous electrolyte will now be described by using, as an example, a case where the nonaqueous electrolyte is contained in the secondary battery.

First, the secondary battery containing the nonaqueous electrolyte to be measured is discharged at 1 C until the battery voltage reaches 1.0 V. The discharged secondary battery is disassembled in a glove box in an inert atmosphere. Next, the nonaqueous electrolyte contained in the battery and the electrode group is extracted. In a case where the nonaqueous electrolyte can be taken out from the portion where the battery is opened, the nonaqueous electrolyte is sampled as it is. On the other hand, in a case where the nonaqueous electrolyte to be measured is held in the electrode group, the electrode group is further disassembled, and for example, a separator impregnated with the nonaqueous electrolyte is taken out. The nonaqueous electrolyte impregnated in the separator can be extracted by using, for example, a centrifuge or the like. Thus, sampling of the nonaqueous electrolyte can be performed. In a case where the amount of the nonaqueous electrolyte contained in the secondary battery is small, the nonaqueous electrolyte can be extracted by immersing the electrode and the separator in an acetonitrile solution. The extraction amount can be calculated by measuring the weight of the acetonitrile solution before and after extraction.

The thus obtained sample of the nonaqueous electrolyte is subjected to, for example, a gas chromatography mass spectrometry apparatus (GC-MS) or nuclear magnetic resonance spectroscopy (NMR) to perform composition analysis. In the analysis, first, components contained in the nonaqueous electrolyte are identified. Next, a calibration curve of each component is prepared. In a case where a plurality of kinds are included, a calibration curve for each component is created. The composition of the nonaqueous electrolyte can be determined by comparing the created calibration curve with the peak intensity or area in the result obtained by measuring the sample of the nonaqueous electrolyte.

By using the nonaqueous electrolyte of the embodiment, since the molar ratio between lithium ions and trialkylsulfonium ions is in the range of 1:4 to 4:1 and the molar ratio between [N(FSO₂)₂]⁻ and [N(CF₃SO₂)₂]⁻ is in the range of 4.2:1 to 1:0, both oxidative decomposition and reductive decomposition of the nonaqueous electrolyte can be suppressed. Thereby, the charge-and-discharge cycle life at a high temperature can be improved. The nonaqueous electrolyte of the embodiment can be used as a nonaqueous electrolyte of a power storage device (for example, a secondary battery or a capacitor) for automobiles, industry, or space. In addition, it can be used for a medium for material synthesis, an actuator, or an electrolyte of a sensitized solar cell by taking advantage of the feature of having ion conductivity stable from low temperature to high temperature and free from volatility. In a secondary battery including a negative electrode containing, as a negative electrode active material, one or more selected from the group consisting of lithium metal, a lithium alloy, and a compound capable of allowing Li to be inserted and extracted, a secondary battery excellent in high energy density, high-temperature cycle performance, and discharge rate performance in a wide temperature range can be obtained.

### Second Embodiment

A second embodiment relates to a secondary battery. A secondary battery includes a positive electrode, a negative electrode, and a nonaqueous electrolyte. Each of the positive electrode and the negative electrode is capable of allowing lithium or lithium ions to be inserted in and extracted from. As the nonaqueous electrolyte, for example, the nonaqueous electrolyte of the embodiment is used. The secondary battery according to the embodiment may further include a separator and a container member. Hereinafter, the positive electrode, the negative electrode, the separator, and the container member will be described.

(1) Positive Electrode

The positive electrode includes a positive electrode active material-containing layer containing a positive electrode active material, and a positive electrode current collector in contact with the positive electrode active material-containing layer. The positive electrode active material-containing layer may be integrated with the positive electrode current collector. The positive electrode active material-containing layer may be a porous body. If the positive electrode active material-containing layer is porous, the nonaqueous electrolyte penetrates to the interface between the positive electrode current collector and the positive electrode active material-containing layer, and a protective film can be easily formed on the positive electrode current collector.

The positive electrode active material may be a compound that allows lithium ions to be inserted and extracted. Examples of the compound that allows lithium ions to be inserted and extracted include metal oxides and lithium metal oxides. Each oxide can provide a high-voltage secondary battery. Examples of the lithium metal oxide include lithium cobalt oxides (for example, Li_{y}CoO₂, 0<y≤1.1), lithium nickel cobalt manganese oxides (for example, Li_{y}NiₐCo_{b}Mn_{c}O₂, a+b+c=1, 0<a, 0<b, 0<c, 0<y≤1.1), lithium nickel cobalt aluminum oxides (for example, Li_{y}NiₐCo_{b}Al_{c}O₂, a+b+c=1, 0<a, 0<b, 0<c, 0<y≤1.1), lithium cobalt phosphate (for example, Li_{y}CoPO₄, 0<y≤1.1), lithium iron phosphate (for example, Li_{y}FePO₄, 0<y≤1.1), fluorinated lithium iron sulfate (for example, Li_{y}FeSO₄F, 0<y≤1.1), lithium iron manganese phosphate (for example, Li_{y}Mn₁₋ₐFeₐPO₄: 0<a≤0.5, 0<y≤1.1), lithium manganese oxides (for example, Li_{y}Mn₂O₄, 0<y≤1.1), lithium nickel manganese oxides (for example, Li_{y}Ni_{0.5}Mn_{1.5}O₄, 0<y≤1.1), lithium nickel manganese oxides having a spinel structure (for example, LiₓNiₐMn₂₋ₐO₄, 0.4≤a<0.6, 0≤x≤1.1), and the like.

More preferred examples of the positive electrode active material are lithium nickel manganese oxides having a spinel structure, lithium cobalt oxides, lithium nickel cobalt manganese oxides, lithium nickel cobalt aluminum oxides, lithium cobalt phosphate, lithium manganese oxides, and the like. The positive electrode active material can exhibit a high voltage of 4 V (vs. Li/Li⁺) or more.

One kind or two or more kinds of positive electrode active materials can be used.

The positive electrode active material-containing layer may contain a conductive agent. Examples of the conductive agent include carbon bodies such as carbon nanofiber, acetylene black, and graphite. The carbon bodies of the above kinds can improve the electronic network in the positive electrode. One kind or two or more kinds of conductive agents can be used. The ratio of the conductive agent in the positive electrode active material-containing layer (excluding the weight of the nonaqueous electrolyte) is preferably 5 wt % or more and 40 wt % or less.

The positive electrode active material-containing layer may contain a binder. Examples of the binder include polyethylene terephthalate, polysulfones, polyimides, cellulose, rubber, and the like. The binders of the above kinds are excellent in chemical stability to the nonaqueous electrolyte. The ratio of the binder in the positive electrode active material-containing layer (excluding the weight of the nonaqueous electrolyte) is preferably 1 wt % or more and 10 wt % or less.

The positive electrode active material-containing layer can contain lithium ion conductive solid electrolyte particles. Thus, the ion conductivity of the positive electrode can be enhanced. Examples of the lithium ion conductive solid electrolyte may include those similar to those described in the first embodiment.

As an example of the positive electrode current collector, a porous body, a mesh, or a foil of one or more metals selected from the group consisting of stainless steel, aluminum, and an aluminum alloy can be used. The thickness of the positive electrode current collector is preferably 10 μm or more and 20 μm or less. The porosity of the positive electrode current collector is preferably 30% or more and 98% or less. The porosity is more preferably 50% or more and 60% or less.

The thickness of the positive electrode varies depending on the electrode shape and the use. If the electrode group structure is a stack structure or a wound structure, the thickness of the positive electrode is preferably 30 μm or more and 100 μm or less for high-output uses, and 100 μm or more and 500 μm or less for high-energy uses.

(2) Negative Electrode

The negative electrode contains a negative electrode active material capable of allowing lithium, lithium alloy, or lithium ions to be inserted and extracted. Examples of the negative electrode active material include lithium metal, a lithium alloy, and a compound capable of allowing Li to be inserted and extracted. One kind or two or more kinds of negative electrode active materials can be used.

Since the negative electrode containing lithium metal has a high capacity and can have a high battery voltage and a low weight, the energy density of the secondary battery can be increased.

The compound capable of allowing Li to be inserted and extracted is a compound capable of allowing lithium, a lithium alloy, or lithium ions to be inserted and extracted. Examples of the compound include a carbonaceous material, silicon, a silicon oxide, lithium-containing graphite in which lithium ions are inserted, a lithium-containing carbon body in which lithium ions are inserted, a compound having a lithium ion inserted/extracted potential of 0.4 V (vs. Li/Li⁺) or more, and the like. Examples of the compound having a lithium ion inserted/extracted potential of 0.4 V (vs. Li/Li⁺) or more include titanium-containing oxides, niobium-containing oxides, titanium-niobium-containing oxides, and the like. Examples of the titanium-containing oxide include lithium titanium oxides (for example, a lithium titanium oxide having a spinel structure such as Li₄₊ₓTi₅O₁₂ (0≤x≤3), for example, a lithium titanium oxide having a ramsdellite structure such as Li_{2+y}Ti₃O₇, 0≤y≤3) and titanium oxides (monoclinic titanium dioxide, TiO₂ (B), anatase titanium dioxide, rutile titanium dioxide, etc.). Examples of the niobium-containing oxide include niobium oxides (Nb₂O₅, Nb₁₂O₂₉, etc.) and niobium tungsten oxides (Nb₁₆W₅O₅₅, Nb₁₈W₈O₆₉, etc.). Examples of the titanium-niobium-containing oxide include Ti₂Nb₂O₉, monoclinic titanium-niobium-containing oxides such as TiNb₂O₇, and the like. The titanium-niobium-containing oxide may be a titanium-niobium-containing oxide in which at least a part of Nb and/or Ti is substituted with another element (a first element). Examples of the first element are Na, K, Ca, Co, Ni, Si, P, V, Cr, Mo, Ta, Zr, Mn, Fe, Mg, B, Pb, Al, and the like. The titanium-niobium-containing oxide may contain one kind of first element or two or more kinds of first elements.

Examples of the monoclinic titanium-niobium-containing oxide include a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The subscripts in the composition formula satisfy 0≤x≤5, 0≤y<1, 0≤z<2, and −0.3≤δ≤0.3.

Other examples of the monoclinic titanium-niobium-containing oxide include a compound represented by Ti_{1-y}M3_{y+z}Nb_{2-z}O_{7-δ}. Here, M3 is at least one selected from Mg, Fe, Ni, Co, W, Ta, and Mo. The subscripts in the composition formula satisfy 0≤y<1, 0≤z<2, and −0.3≤δ≤0.3.

Each of a spinel-type lithium titanium oxide such as Li₄Ti₅O₁₂ and a monoclinic titanium-niobium-containing oxide such as TiNb₂O₇ exhibits excellent cycle life performance even in an ionic liquid.

Examples of the lithium alloy include alloys such as Li—Al, Li—Si, Li—Zn, and Li—Mg. The Li—Mg alloy can suppress Li dendrite deposition. The molar content ratio of Mg in the Li—Mg alloy is preferably in the range of 0.05 or more and 0.15 or less.

The lithium metal and the lithium alloy each preferably have a foil shape.

Examples of the carbonaceous material include a graphite material and a carbon material. Examples of the carbon material include hard carbon.

The negative electrode may include a negative electrode active material-containing layer. The negative electrode active material-containing layer may contain a conductive agent and/or a binder. The negative electrode active material-containing layer may be in contact with the negative electrode current collector or integrated with the negative electrode current collector. The negative electrode active material-containing layer may be a porous body. If the negative electrode active material-containing layer is porous, the nonaqueous electrolyte penetrates to the interface between the negative electrode current collector and the negative electrode active material-containing layer, and a protective film can be easily formed on the negative electrode current collector.

As the conductive agent, for example, a carbon material, a metal compound powder, a metal powder, or the like can be used. Examples of the carbon material include acetylene black, carbon black, coke, carbon fiber, graphite, carbon nanotubes, and the like. The BET specific surface area of the carbon material by N₂ adsorption is preferably 10 m²/g or more. Examples of the metal compound powder include powders of TiO, TiC, and TiN. Examples of the metal powder include powders of Al, Ni, Cu, and Fe. Preferred examples of the conductive agent include coke having a heat treatment temperature of 800° C. to 2000° C. and an average particle size of 10 μm or less, graphite, acetylene black, carbon fiber having an average fiber diameter of 1 μm or less, and TiO powder. By using one or more kinds selected from these, a reduction in electrode resistance and an improvement in cycle life performance can be achieved. One kind or two or more kinds of conductive agents can be used.

Examples of the binder include polytetrafluoroethylene (PTFE), polyvinylidene fluoride (PVdF), fluororubber, acrylic rubber, styrene butadiene rubber, core-shell binder, polyimides, carboxymethyl cellulose (CMC), and the like. One kind or two or more kinds of binders can be used.

The negative electrode active material-containing layer containing a compound capable of allowing Li to be inserted and extracted (hereinafter, the compound is referred to as a first compound) can be prepared by, for example, suspending the first compound, the conductive agent, and the binder in an appropriate solvent, applying the suspension to a current collector, and performing drying and pressing. The blending ratio of the first compound, the conductive agent, and the binder is preferably in the range of 80 to 95 wt % of the first compound, 3 to 18 wt % of the conductive agent, and 2 to 7 wt % of the binder. Each of lithium metal foil and lithium alloy foil may be used as the negative electrode active material-containing layer.

In order to enhance the ion conductivity in the negative electrode, it is preferable to incorporate lithium ion conductive solid electrolyte particles into the negative electrode. The negative electrode may contain an ionic liquid, a fibrous polymer body having an average fiber diameter of 1 to 100 nm, and lithium ion conductive solid electrolyte particles having an average particle size of 1 μm or less. The fibrous polymer body is preferably cellulose fiber (cellulose nanofiber) because the electrode resistance is reduced. Such a fibrous polymer body has a nano-sized fiber diameter of 1 to 100 nm as an average fiber diameter, has an extremely large aspect ratio (in a range of 100 to 10000), and can firmly hold the liquid nonaqueous electrolyte in a fine network space of fibers, so that disconnection of ion conduction associated with expansion and shrinkage of the electrode active material can be suppressed in the negative electrode and an improvement in cycle life performance and a reduction in electrode resistance can be achieved. Examples of the lithium ion conductive solid electrolyte and the ionic liquid may include those similar to those described in the first embodiment.

The negative electrode current collector can be formed of, for example, copper, aluminum, or an aluminum alloy. The shape of the negative electrode current collector can be a sheet shape such as a foil. A material for forming the negative electrode current collector is selected according to the kind of the negative electrode active material. In a case where lithium metal, a lithium alloy, or a carbonaceous material is contained as the negative electrode active material, copper foil can be used as the negative electrode current collector. In a case where a compound having a lithium ion inserted/extracted potential of 0.4 V (vs. Li/Li⁺) or more is used as the negative electrode active material, aluminum foil or aluminum alloy foil can be used as the negative electrode current collector. The thickness of each of the aluminum foil and the aluminum alloy foil is 20 μm or less, more preferably 15 μm or less. The purity of the aluminum foil is preferably 99% or more, more preferably 99.99% or more. The aluminum alloy is preferably an alloy containing an element such as magnesium, zinc, or silicon. On the other hand, the content of transition metals such as iron, copper, nickel, and chromium in the negative electrode current collector containing aluminum is preferably set to 100 ppm or less.

The thickness of the negative electrode varies depending on the electrode shape and the use. If the electrode group structure is a stack structure or a wound structure, the thickness of the negative electrode is preferably 30 to 500 μm.

(3) Separator

The separator can be provided on at least one surface of the positive electrode, on at least one surface of the negative electrode, or between the positive electrode and the negative electrode. The separator may be in contact with the positive electrode, the negative electrode, or the positive and negative electrodes, but may be integrated with the positive electrode, the negative electrode, or the positive and negative electrodes.

Examples of the separator include a nonwoven fabric, a porous membrane, and a lithium ion conductive solid electrolyte membrane. Examples of the material for forming the nonwoven fabric include polymer fibers such as cellulose, polyacrylonitrile (PAN), and polyimides, inorganic fibers such as alumina and silica, and the like. Examples of the material for forming the porous membrane include polyethylene (PE), polypropylene (PP), and polyimides. In a case where the viscosity of the ionic liquid is high, the porosity of the separator can be set to 60% or more and 80% or less. The thickness of the separator can be 5 μm or more and 50 μm or less.

At least one main surface of the separator or a positive electrode surface and/or a negative electrode surface in contact with the separator is preferably coated with inorganic oxide particles. Examples of the inorganic oxide particles include alumina particles, titania particles, and lithium conductive solid electrolyte particles. One kind or two or more kinds of inorganic oxide particles can be used. Examples of the lithium conductive solid electrolyte may include those similar to those described in the first embodiment.

One kind or two or more kinds of separators can be used. For example, a separator including a solid electrolyte membrane having lithium ion conductivity and a separator including a nonwoven fabric or a porous membrane can be used in an overlapping manner.

(4) Container Member

The secondary battery may include a container member. The container member includes a container having an opening, and a lid attached to the opening of the container. The lid may be a member separate from or integrated with the container. In addition, the container member only needs to be capable of housing the positive electrode, the negative electrode, the separator, and the nonaqueous electrolyte, and is not limited to the structure shown in the drawings. A container member having a shape corresponding to a prismatic, thin, cylindrical, or coin-shaped battery may be used.

Materials constituting the container member include a metal, a laminate film, etc.

Examples of the metal include iron, stainless steel, aluminum, nickel, and the like. In a case where a metal can is used for the container, the plate thickness of the container is desirably set to 0.5 mm or less, and a more preferred range is 0.3 mm or less.

Examples of the laminate film include a multilayer film in which aluminum foil or stainless steel foil is covered with a resin film, and the like. As the resin, polymers such as polypropylene (PP), polyethylene (PE), nylon, and polyethylene terephthalate (PET) can be used. The thickness of the laminate film is preferably set to 0.2 mm or less.

Next, a secondary battery according to an embodiment will be described with reference to the drawings.

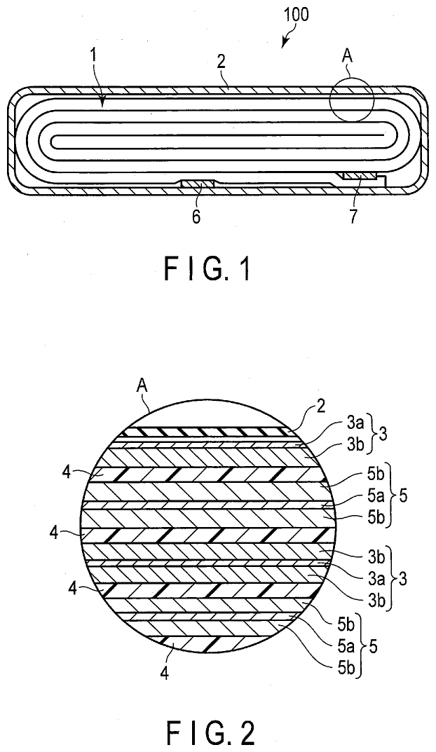

FIG. 1 is a cross-sectional view schematically showing an example of a secondary battery according to an embodiment. FIG. 2 is an enlarged cross-sectional view of part A of the secondary battery shown in FIG. 1.

A secondary battery 100 shown in FIGS. 1 and 2 includes a bag-shaped container member 2 shown in FIGS. 1 and 2, an electrode group 1 shown in FIG. 1, and a nonaqueous electrolyte (not shown). The electrode group 1 and the nonaqueous electrolyte are housed in the bag-shaped container member 2. The nonaqueous electrolyte (not shown) is held in the electrode group 1.

The bag-shaped container member 2 includes a laminate film including two resin layers and a metal layer interposed therebetween.

As shown in FIG. 1, the electrode group 1 is a flat wound electrode group. As shown in FIG. 2, the flat wound electrode group 1 includes a negative electrode 3, a separator 4, and a positive electrode 5. The separator 4 is interposed between the negative electrode 3 and the positive electrode 5.

The negative electrode 3 includes a negative electrode current collector 3a and a negative electrode mixture layer (active material-containing layer) 3b. In the portion of the negative electrode 3 located in the outermost shell of the wound electrode group 1, as shown in FIG. 2, the negative electrode mixture layer 3b is formed only on the inner surface side of the negative electrode current collector 3a. In the other part of the negative electrode 3, the negative electrode mixture layer 3b is formed on both surfaces of the negative electrode current collector 3a.

The positive electrode 5 includes a positive electrode current collector 5a and positive electrode mixture layers (positive electrode active material-containing layers) 5b formed on both sides of the positive electrode current collector 5a.

As shown in FIG. 1, the negative electrode terminal 6 and the positive electrode terminal 7 are located near the outer peripheral end of the wound electrode group 1. The negative electrode terminal 6 is electrically connected to a portion located at the outermost shell of the negative electrode current collector 3a. The positive electrode terminal 7 is electrically connected to a portion located at the outermost shell of the positive electrode current collector 5a. The negative electrode terminal 6 and the positive electrode terminal 7 extend to the outside from the opening of the bag-shaped container member 2. A thermoplastic resin layer is provided on the inner surface of the bag-shaped container member 2, and the opening is closed by thermally fusing the thermoplastic resin layer.

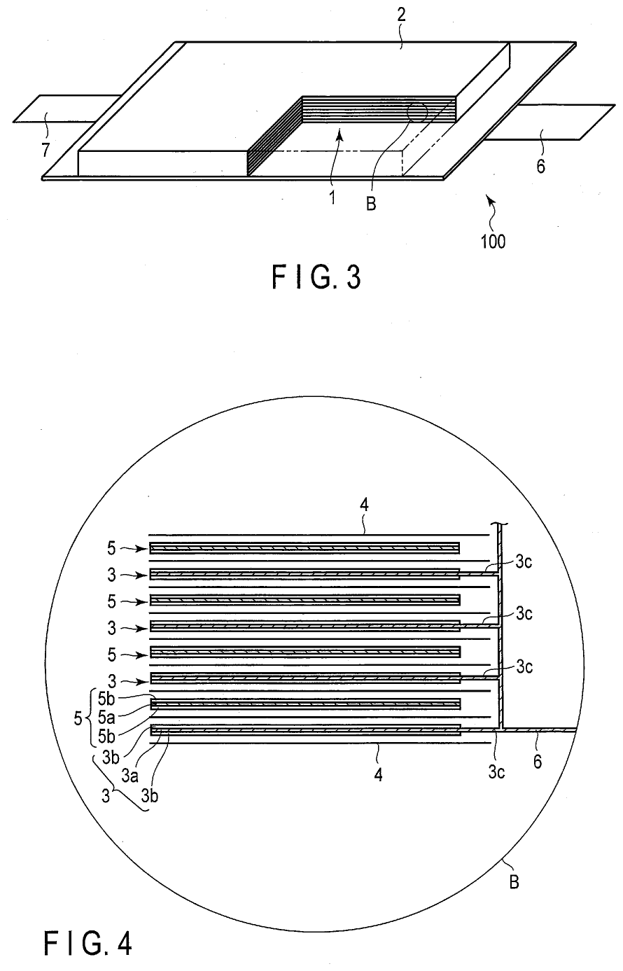

The secondary battery according to the embodiment is not limited to the secondary battery of the configuration shown in FIGS. 1 and 2, and may be, for example, a battery of the configuration shown in FIGS. 3 and 4.

FIG. 3 is a partially cutaway perspective view schematically showing another example of the secondary battery according to the embodiment. FIG. 4 is an enlarged cross-sectional view of part B of the secondary battery shown in FIG. 3.

A secondary battery 100 shown in FIGS. 3 and 4 includes an electrode group 1 shown in FIGS. 3 and 4, a container member 2 shown in FIG. 3, and a nonaqueous electrolyte (not shown). The electrode group 1 and the nonaqueous electrolyte are housed in the container member 2. The nonaqueous electrolyte is held in the electrode group 1.

The container member 2 includes a laminate film including two resin layers and a metal layer interposed therebetween.

As shown in FIG. 4, the electrode group 1 is a stacked electrode group. The stacked electrode group 1 has a structure in which the negative electrode 3 and the positive electrode 5 are alternately stacked with the separator 4 interposed therebetween.

The electrode group 1 includes a plurality of negative electrodes 3. Each of the plurality of negative electrodes 3 includes a negative electrode current collector 3a and a negative electrode mixture layer 3b supported on both surfaces of the negative electrode current collector 3a. The electrode group 1 includes a plurality of positive electrodes 5. Each of the plurality of positive electrodes 5 includes a positive electrode current collector 5a and a positive electrode mixture layer 5b supported on both surfaces of the positive electrode current collector 5a.

The negative electrode current collector 3a of each negative electrode 3 includes, on one side thereof, a portion 3c where the negative electrode mixture layer 3b is not supported on any surface. The portion 3c serves as a negative electrode tab. As shown in FIG. 4, the portion 3c serving as the negative electrode tab does not overlap with the positive electrode 5. The plurality of negative electrode tabs (portions 3c) are electrically connected to a belt-shaped negative electrode terminal 6. The tip of the belt-shaped negative electrode terminal 6 is drawn out of the container member 2.

Although not shown, the positive electrode current collector 5a of each positive electrode 5 includes, on one side thereof, a portion where the positive electrode mixture layer 5b is not supported on any surface. This portion serves as a positive electrode tab. The positive electrode tab does not overlap with the negative electrode 3. The positive electrode tab is located on the opposite side of the electrode group 1 with respect to the negative electrode tab (portion 3c). The positive electrode tab is electrically connected to the belt-shaped positive electrode terminal 7. The tip of the belt-shaped positive electrode terminal 7 is located on the opposite side to the negative electrode terminal 6, and is drawn out of the container member 2.

Since the secondary battery according to the embodiment described above includes the nonaqueous electrolyte of the first embodiment, a high-voltage secondary battery excellent in high-temperature cycle performance and discharge rate performance can be provided.

### Third Embodiment

According to a third embodiment, a battery pack is provided. The battery pack includes the secondary battery according to the second embodiment. The battery pack may include one secondary battery according to the second embodiment or include a battery module constituted by secondary batteries according to the second embodiment.

The battery pack according to the embodiment may further include a protective circuit. The protective circuit has a function to control the charge and discharge of the secondary battery. Alternatively, a circuit included in equipment where the battery pack serves as a power source (for example, electronic devices, automobiles, and the like) may be used as the protective circuit of the battery pack.

Moreover, the battery pack according to the embodiment may further include an external power distribution terminal. The external power distribution terminal is configured to externally output current from the secondary battery, and/or to input external current into the secondary battery. In other words, when the battery pack is used as a power source, the current is supplied to the outside through the external power distribution terminal. When the battery pack is charged, the charging current (including regenerative energy from the motive force of automobiles and the like) is supplied to the battery pack via the external power distribution terminal.

Next, an example of the battery pack according to the embodiment will be described with reference to the drawings.

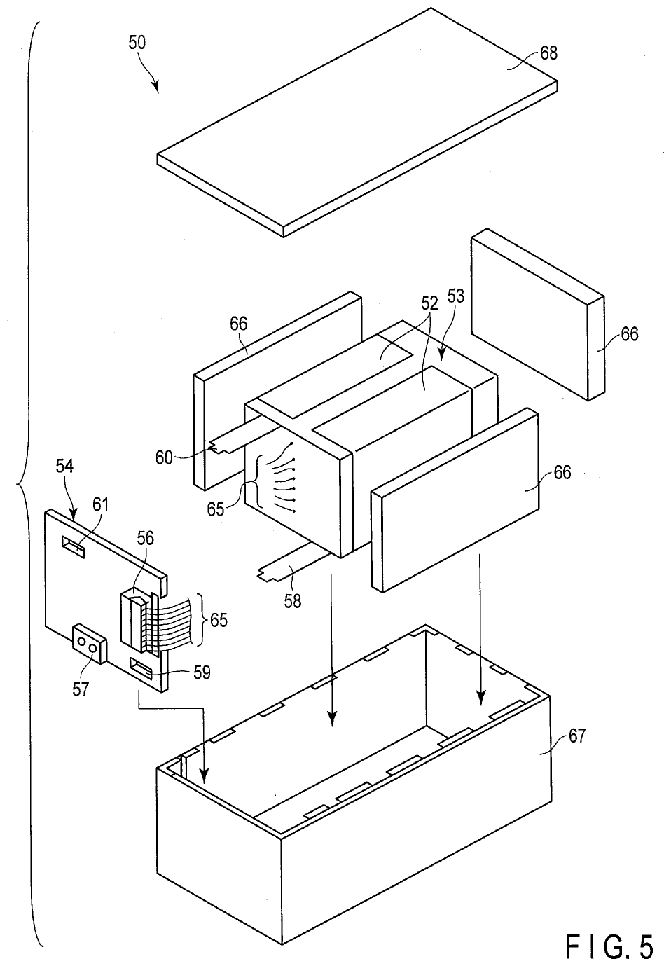

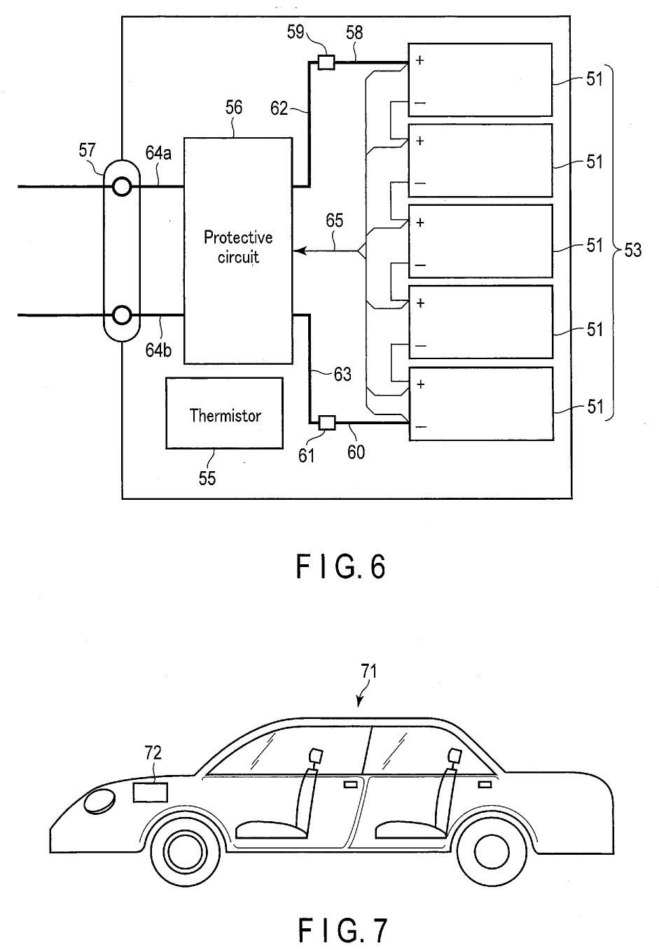

FIG. 5 is an exploded perspective view schematically showing an example of the battery pack according to the embodiment that is disassembled for each part. FIG. 6 is a block diagram showing an example of an electric circuit of the battery pack shown in FIG. 5.

FIGS. 5 and 6 show an example of a battery pack 50. The battery pack 50 shown in FIGS. 5 and 6 includes multiple secondary batteries according to the embodiment. Multiple secondary batteries 51 are stacked so that the negative electrode terminals and the positive electrode terminals are aligned in the same direction and fastened with an adhesive tape 52 to constitute a battery module 53. These secondary batteries 51 are electrically connected to each other in series as shown in FIG. 6.

A printed wiring board 54 is arranged to face the plane of the secondary battery 51 where the negative electrode terminal and the positive electrode terminal are disposed. A thermistor 55, a protective circuit 56, and an external power distribution terminal 57 to an external device are mounted on the printed wiring board 54 as shown in FIG. 6. An insulating plate (not shown) is attached to the surface of the printed wiring board 54 facing the battery module 53 to avoid unnecessary connection with the wires of the battery module 53.

A positive electrode-side lead 58 is connected to the positive electrode terminal positioned at the bottom layer of the battery module 53, and the distal end of the lead 58 is inserted into a positive electrode-side connector 59 of the printed wiring board 54 so as to be electrically connected. A negative electrode-side lead 60 is connected to the negative electrode terminal positioned at the top layer of the battery module 53, and the distal end of the lead 60 is inserted into a negative electrode-side connector 61 of the printed wiring board 54 so as to be electrically connected. The connectors 59 and 61 are connected to the protective circuit 56 through wires 62 and 63 formed on the printed wiring board 54.

The thermistor 55 detects the temperature of the secondary batteries 51, and the detection signal is sent to the protective circuit 56. The protective circuit 56 can shut down a plus-side wire 64a and a minus-side wire 64b between the protective circuit 56 and the external power distribution terminal 57 to an external device under a predetermined condition. An example of the predetermined condition is a state in which the temperature detected by the thermistor 55 reaches a predetermined level or higher. Another example of the predetermined condition is a state in which overcharge, overdischarge, over-current, and the like of the secondary batteries 51 is detected. The detection of the overcharge and the like is performed either on individual secondary batteries 51 or the secondary batteries 51 in their entirety. When each of the secondary batteries 51 is to be detected, the battery voltage may be detected, or a positive electrode potential or a negative electrode potential may be detected. In the latter case, a lithium electrode to be used as a reference electrode is inserted into each of the secondary batteries 51. In the case of the battery pack shown in FIGS. 5 and 6, wires 65 for voltage detection are connected to each of the secondary batteries 51, and detection signals are sent to the protective circuit 56 through the wires 65.

Protective sheets 66 made of rubber or resin are arranged on three side surfaces of the battery module 53 except on the side surface from which the positive electrode terminal and the negative electrode terminal protrude.

The battery module 53 is housed in a housing container 67 together with each of the protective sheets 66 and the printed wiring board 54. That is, the protective sheets 66 are arranged on both inner side surfaces in the long-side direction and an inner side surface in the short-side direction of the housing container 67, and the printed wiring board 54 is disposed on the opposite inner side surface in the short-side direction. The battery module 53 is positioned in a space surrounded by the protective sheets 66 and the printed wiring board 54. A lid 68 is attached to the upper surface of the housing container 67.

In order to fix the battery module 53, a heat-shrinkable tape may be used in place of an adhesive tape 52. In this case, the battery module is bound by placing the protective sheets on the both sides of the battery module, winding the heat-shrinkable tape around the battery module, and then thermally shrinking the heat-shrinkable tape.

FIGS. 5 and 6 show the configuration in which the secondary batteries 51 are connected in series; however, the secondary batteries may be connected in parallel to increase the battery capacity. Alternatively, the batteries may be connected in a combination of in series and in parallel. The assembled battery pack can also be connected in series or in parallel.

The battery pack shown in FIGS. 5 and 6 includes a single battery module; however, the battery pack according to the embodiment may include battery modules. The battery modules are electrically connected in series, in parallel, or in a combination of series connection and parallel connection.

The aspect of the battery pack can be appropriately changed depending on the applications. The battery pack according to the present embodiment is suitably used in applications where excellent cycle performance is demanded during extraction of a large current. More specifically, the battery pack is used as a power supply for a digital camera, a battery for a vehicle such as a two- or four-wheeled hybrid electric automobile, a two- or four-wheeled electric automobile, an electric assist bicycle, or a railway vehicle (for example, an electric train), or a stationary battery. In particular, the battery pack is suitably used as a large-sized storage battery for a stationary power storage system or an in-vehicle battery for vehicles.

A battery pack according to the embodiment includes the secondary battery according to the embodiment. Therefore, the battery pack according to the embodiment has high energy density, and is excellent in high-temperature cycle performance and discharge rate performance.

### Fourth Embodiment

According to a fourth embodiment, a vehicle is provided. The vehicle includes the battery pack according to the embodiment.

In the vehicle according to the embodiment, the battery pack is configured, for example, to recover regenerative energy from the motive force of the vehicle. The vehicle may include a mechanism configured to convert kinetic vehicular energy into regenerative energy.

Examples of the vehicle include two- to four-wheeled hybrid electric automobiles, two- to four-wheeled electric automobiles, electric assist bicycles, and railway cars.

The installation position of the battery pack in the vehicle is not particularly limited. For example, when installing the battery pack in an automobile, the battery pack can be installed in the engine compartment of the vehicle, in a rear part of the vehicle body, or under seats.

The vehicle may include battery packs. In this case, the battery packs may be electrically connected in series, electrically connected in parallel, or electrically connected in a combination of in-series and in-parallel connections.

Next, an example of the vehicle according to the embodiment will be described with reference to the drawings.

FIG. 7 is a cross-sectional view schematically showing an example of the vehicle according to the embodiment.

The vehicle 71 shown in FIG. 7 includes a vehicle body and the battery pack 72 according to the embodiment. In the example shown in FIG. 7, the vehicle 71 is a four-wheeled automobile.

The vehicle 71 may include battery packs 72. In this case, the battery packs 72 may be connected in series, in parallel, or in a combination of in-series and in-parallel connections.

In FIG. 7, the battery pack 72 is installed in an engine compartment located at the front of the vehicle body. As described above, the battery pack 72 may be installed in a rear part of the vehicle body, or under seats. The battery pack 72 may be used as a power source of the vehicle. In addition, the battery pack 72 can recover regenerative energy from the motive force from the vehicle.

The vehicle according to the embodiment includes the battery pack according to the embodiment. Thus, the present embodiment can provide a vehicle that includes a battery pack having a high energy density and being excellent in high-temperature cycle performance and discharge rate performance.

### Fifth Embodiment

According to a fifth embodiment, a stationary power supply is provided. The stationary power supply includes the battery pack according to the embodiment. The stationary power supply may include the secondary battery or battery module according to the embodiment, instead of the battery pack according to the embodiment.

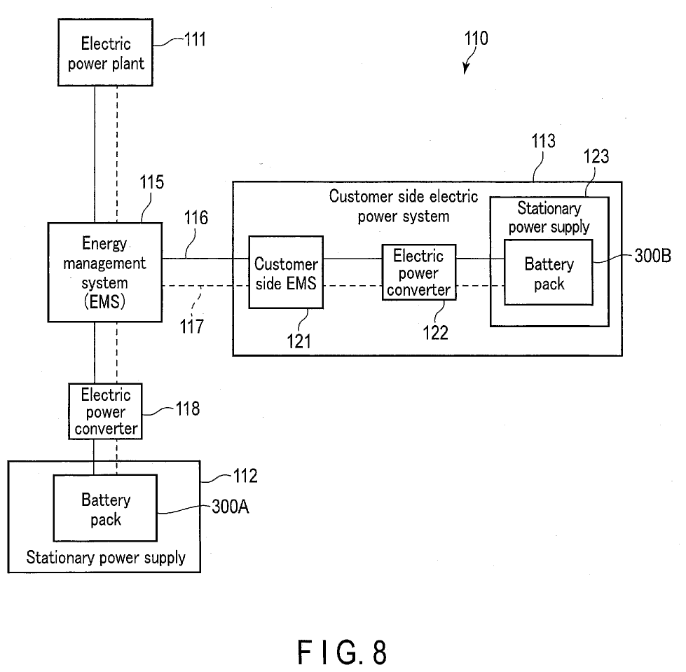

FIG. 8 is a block diagram showing an example of a system including a stationary power supply according to the embodiment. FIG. 8 is a diagram showing an application example to stationary power supplies 112, 123 as an example for use of the battery packs 300A, 300B according to the embodiment. In the example shown in FIG. 8, a system 110 in which the stationary power supplies 112, 123 are used is shown. The system 110 includes an electric power plant 111, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control operations to stabilize the entire system 110 by utilizing the electric power network 116 and the communication network 117.

The electric power plant 111 generates a large amount of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current and alternate current, conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control operations to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

The electric power stored in the battery pack 300B can be used, for example, for charging a vehicle such as an electric car. Also, the system 110 may be provided with a natural energy source. In such a case, the natural energy source generates electric power through natural energy such as wind power and solar light. In addition to the electric power plant 111, electric power is also supplied from the natural energy source through the electric power network 116.

A stationary power supply according to the embodiment includes the battery pack according to the embodiment. Therefore, according to the present embodiment, a stationary power supply including a battery pack having high energy density and excellent in high-temperature cycle performance and discharge rate performance can be provided.

### EXAMPLES

Hereinafter, Examples of the present invention will be described in detail with reference to the drawings; however, the present invention is not limited to the Examples described below.

### Example 1

As a positive electrode active material, a lithium nickel cobalt manganese oxide (LiNi_{0.8}Co_{0.1}Mn_{0.1}O₂) having an average particle size of 4 μm was used. The positive electrode active material was blended with 2 wt % of vapor-grown carbon fiber (VGCF) with a fiber diameter of 0.1 μm as a conductive agent, 6 wt % of graphite powder as the conductive agent, and 5 wt % of PVdF as a binder, and the blend was dispersed in a N-methylpyrrolidone (NMP) solvent to prepare a slurry. The content of each component in the slurry is a value on the assumption that the positive electrode active material-containing layer accounts for 100 wt %. The slurry was applied to a current collector including aluminum foil with a thickness of 10 μm, and drying and pressing were performed; thus, a positive electrode (the density of the positive electrode active material-containing layer: 3.3 g/cm³) was produced.

As a negative electrode active material, monoclinic TiNb₂O₇ particles having an average particle size of 0.9 μm and a specific surface area of 4 m²/g were prepared. The negative electrode active material, graphite powder with an average particle size of 6 μm as a conductive agent, styrene butadiene rubber and carboxymethyl cellulose (CMC) as a binder, Li_{1.3}Al_{0.3}Zr_{1.7}(PO₄)₃ particles having an average particle size of 0.4 μm, and cellulose nanofiber having an average fiber diameter of 10 nm were blended so as to have a weight ratio of 90:5:2:1.9:1:0.1, were dispersed in water, and were stirred using a ball mill under the conditions of a rotation rate of 1000 rpm and a stirring time of 1 hour to prepare a slurry. The obtained slurry was applied to aluminum alloy foil (purity: 99.3%) having a thickness of 15 μm, drying was performed, and a heating pressing step was performed; thus, a negative electrode having a density of 2.6 g/cm³ per one of the negative electrode active material-containing layer was produced. The porosity of the negative electrode excluding the current collector was 35%.

As a nonaqueous electrolyte, a triethylsulfonium salt represented by S222FSI, a triethylsulfonium salt represented by S222TFSI, and a lithium salt represented by LiFSI were mixed and adjusted so as to have molar fractions of 0.5, 0.1, and 0.4, respectively; thus, an ionic liquid was prepared. The molar ratio between lithium ions and S222, which is the molar ratio between Li and the organic cation, is 2:3. The molar ratio between [N(FSO₂)₂]⁻ (FIS) and [N(CF₃SO₂)₂]⁻ (TFSI) (FIS:TFSI) is 9:1.

100 parts by weight of Al₂O₃ particles having an average particle size of 1 μm and 4 parts by weight of polyvinylidene fluoride were dispersed in NMP to prepare a slurry. The slurry was applied to one surface of a porous layer including a cellulose nonwoven fabric having a thickness of 30 μm, and drying was performed to form an alumina particle layer having a thickness of 3 μm on the one surface of the porous layer; thus, a separator was obtained.

The positive electrode and the negative electrode were alternately stacked such that the separator was positioned therebetween; thus, an electrode group was fabricated. The alumina particle layer of the separator was brought into contact with the active material-containing layer of the positive electrode. This electrode group was housed in a container including an aluminum-containing laminate film having a thickness of 0.1 mm; thus, a thin secondary battery having the structure shown in FIG. 1 was produced. The secondary battery had a size of 7 mm×40 mm×60 mm, a capacity of 2 Ah, an average voltage of 2.25 V, and a weight of 35 g. Examples 2 to 4, 6, 7, and 10

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3.

### Example 5

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3. The average particle size of Nb₁₆W₅O₅₅ used in Example 5 is 2 μm.

### Example 8

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3. The average particle size of Li₄Ti₅O₁₂ of a spinel structure used in Example 8 is 0.8 μm.

### Example 9

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3. The average particle size of LiMn₂O₄ used in Example 9 is 5 μm.

### Example 11

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3. The average particle size of LiNi_{0.5}Mn_{1.3}O₄ having a spinel structure used in Example 11 is 5 μm.

### Example 12

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3. The LiCoPO₄ particles used in Example 12 have an olivine structure, an average particle size of 3 μm, and carbon fine particles (average particle size: 0.005 μm) adhered (adhesion amount: 0.1 wt %) to the particle surface.

### Example 13

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3.

A method for producing the negative electrode is as follows.

Graphite powder and polyvinylidene fluoride (PVdF) were mixed at a weight ratio of 90:10, and the resulting mixture was kneaded in the presence of an organic solvent (N-methylpyrrolidone) to prepare a slurry. The obtained slurry was applied to copper foil having a thickness of 15 μm, and drying and pressing were performed; thus, a negative electrode was obtained.

### Example 14

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3.

The negative electrode was produced by pressure-bonding lithium metal foil having a thickness of 50 μm to copper current collector foil having a thickness of 10 μm.

### Example 15

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3.

A method for producing the negative electrode is as follows. Foil containing Li_{0.9}Mg_{0.1} alloy and having a thickness of 50 μm was pressure-bonded to a copper foil current collector having a thickness of 10 μm; thus, a negative electrode was produced.

### Example 16

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3.

A method for producing the negative electrode is as follows.

Graphite powder, SiO powder, and polyvinylidene fluoride (PVdF) were mixed at a weight ratio of 80:10:10, and the resulting mixture was kneaded in the presence of an organic solvent (N-methylpyrrolidone) to prepare a slurry. The obtained slurry was applied to copper foil having a thickness of 15 μm, and drying and pressing were performed; thus, a negative electrode was obtained.

### Example 17

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3.

A method for producing the negative electrode is as follows.

Graphite powder, Si powder, and polyvinylidene fluoride (PVdF) were mixed at a weight ratio of 80:10:10, and the resulting mixture was kneaded in the presence of an organic solvent (N-methylpyrrolidone) to prepare a slurry. The obtained slurry was applied to copper foil having a thickness of 15 μm, and drying and pressing were performed; thus, a negative electrode was obtained.

### Example 18

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 1 and 3.

As nonaqueous electrolytes, S222FSI, S222TFSI, and LiFSI were mixed such that the molar fractions were 0.25, 0.15, and 0.6, respectively; thus, an ionic liquid was prepared. 5 wt % of FEC was added to the ionic liquid to prepare a liquid nonaqueous electrolyte. The molar ratio between lithium ions and S222 is 3:2. The molar ratio between [N(FSO₂)₂]⁻ (FIS) and [N(CF₃SO₂)₂]⁻ (TFSI) is 5.7:1.

### Example 19

A thin nonaqueous electrolyte secondary battery was produced in a similar manner to Example 7 except that S111FSI and S111TFSI were used instead of the triethylsulfonium salt.

### Example 20

A thin nonaqueous electrolyte secondary battery was produced in a similar manner to Example 7 except that S223FSI and S223TFSI were used instead of the triethylsulfonium salt.

### Example 21

A thin nonaqueous electrolyte secondary battery was produced in a similar manner to Example 7 except that S123FSI and S123TFSI were used instead of the triethylsulfonium salt.

### Example 22

A thin nonaqueous electrolyte secondary battery was produced in a similar manner to Example 7 except that S222FSI and S111TFSI were used.

### Comparative Examples 1 to 9

A thin nonaqueous electrolyte secondary battery was produced in a similar manner to that described in Example 1 except that the positive electrode active material, the negative electrode active material, the nonaqueous electrolyte composition (molar fractions), Li:organic cation (molar ratio), and FSI:TFSI (molar ratio) were set as shown in Tables 2 and 4. EMI represents 1-ethyl-3-methylimidazolium. The nonaqueous electrolytic solution of Comparative Example 9 is obtained by dissolving 1.2 M LiPF₆ in a nonaqueous solvent in which propylene carbonate (PC) and diethyl carbonate (DEC) are mixed at a volume ratio of 1:2.

The molar fraction of the nonaqueous electrolyte composition in Table 3 indicates the molar fraction of the compound constituting the nonaqueous electrolyte. In addition, Li:organic cation (molar ratio) is the molar ratio between lithium ions and organic cations, which are cation components of the ionic liquid. FSI:TFSI (molar ratio) is the molar ratio between FSI and TFSI, which are anion components of the ionic liquid.

The discharge capacity (Ah), average voltage (V), energy (Wh), high-temperature charge-discharge cycle performance, and 1 C discharge rate performance of each of the obtained nonaqueous electrolyte secondary batteries of Examples and Comparative Examples were measured by the following methods, and the measurement results are shown in Tables 5 and 6.

The secondary batteries of Examples 1 to 10 and 18 to 22 and Comparative Examples 1 to 3 and 5 to 9 were charged with a constant current of 0.4 A to 2.9 V at 45° C., and then discharged with 0.2 A to 1.5 V; and the discharge capacity (Ah), the average voltage (V), and the energy (Wh) were measured. The average voltage was calculated from the relationship of V=Wh/Ah. As a high-temperature charge-and-discharge cycle test, a charge-and-discharge cycle in which each secondary battery was charged with a constant current of 0.5 A to 2.9 V at 70° C. and then discharged with 0.5 A to 1.5 V was repeated, and the number of cycles at which the capacity retention ratio reached 80% was determined as a cycle life count. A discharge capacity C1 at the time of discharging with a 1 C rate (corresponding to 2 A) in a 45° C. environment and a discharge capacity C2 at the time of discharging with a 0.2 C rate in a 45° C. environment were measured, and the value of C1/C2 was obtained as discharge rate performance with 1 C at 45° C.

The secondary batteries of Examples 11 and 12 and Comparative Example 4 were charged with a constant current of 0.4 A to 3.7 V at 45° C., and then discharged with 0.2 A to 2.2 V; and the discharge capacity (Ah), the average voltage (V=Wh/Ah), and the energy (Wh) were measured. In addition, a charge-and-discharge cycle in which each secondary battery was charged with a constant current of 0.5 A to 3.7 V at 70° C. and then discharged with 0.5 A to 2.2 V was repeated, and the number of cycles at which the capacity retention ratio reached 80% was determined as the cycle life count. A discharge capacity C1 at the time of discharging with a 1 C rate in a 45° C. environment and a discharge capacity C2 at the time of discharging with a 0.2 C rate in a 45° C. environment were measured, and the value of C1/C2 was obtained as discharge rate performance with 1 C at 45° C.

The secondary batteries of Examples 13 to 17 were charged with a constant current of 0.4 A to 4.2 V at 45° C., and then discharged with 0.2 A to 2.7 V; and the discharge capacity (Ah), the average voltage (V=Wh/Ah), and the energy (Wh) were measured. In addition, a charge-and-discharge cycle in which each secondary battery was charged with a constant current of 0.5 A to 4.2 V at 70° C. and then discharged with 0.5 A to 2.7 V was repeated, and the number of cycles at which the capacity retention ratio reached 80% was determined as the cycle life count. A discharge capacity C1 at the time of discharging with a 1 C rate in a 45° C. environment and a discharge capacity C2 at the time of discharging with a 0.2 C rate in a 45° C. environment were measured, and the value of C1/C2 was obtained as discharge rate performance with 1 C at 45° C.

TABLE 1

| | Positive electrode | Negative electrode |
|---|---|---|
| | active material | active material |
| Example 1 | LiNi_{0.8}Co_{0.1}Mn_{0.1}O₂ | TiNb₂O₇ |
| Example 2 | LiNi_{0.8}Co_{0.1}Mn_{0.1}O₂ | TiNb₂O₇ |
| Example 3 | LiNi_{0.8}Co_{0.1}Mn_{0.1}O₂ | TiNb₂O₇ |
| Example 4 | LiNi_{0.8}Co_{0.1}Mn_{0.1}O₂ | TiNb₂O₇ |
| Example 5 | LiNi_{0.8}Co_{0.1}Mn_{0.1}O₂ | Nb₁₆W₅O₅₅ |
| Example 6 | LiNi_{0.8}Co_{0.1}Mn_{0.1}O₂ | TiNb₂O₇ |
| Example 7 | LiNi_{0.8}Co_{0.1}Mn_{0.1}O₂ | TiNb₂O₇ |
| Example 8 | LiNi_{0.8}Co_{0.1}Mn_{0.1}O₂ | Li₄Ti₅O₁₂ |
| Example 9 | LiMn₂O₄ | TiNb₂O₇ |
| Example 10 | LiNi_{0.8}Co_{0.1}Mn_{0.1}O₂ | TiNb₂O₇ |
| Example 11 | LiNi_{0.5}Mn_{1.5}O₄ | TiNb₂O₇ |
| Example 12 | LiCoPO₄ | TiNb₂O₇ |
| Example 13 | LiNi_{0.8}Co_{0.1}Mn_{0.1}O₂ | graphite |
| Example 14 | LiNi_{0.8}Co_{0.1}Mn_{0.1}O₂ | Li |
| Example 15 | LiNi_{0.8}Co_{0.1}Mn_{0.1}O₂ | Li_{0.9}Mg_{0.1} |
| Example 16 | LiNi_{0.8}Co_{0.1}Mn_{0.1}O₂ | graphite and SiO (10%) |
| Example 17 | LiNi_{0.8}Co_{0.1}Mn_{0.1}O₂ | graphite and Si (10%) |
| Example 18 | LiNi_{0.8}Co_{0.1}Mn_{0.1}O₂ | TiNb₂O₇ |
| Example 19 | LiNi_{0.8}Co_{0.1}Mn_{0.1}O₂ | TiNb₂O₇ |

TABLE 2

| | Positive electrode | Negative electrode |
|---|---|---|
| | active material | active material |
| Example 20 | LiNi_{0.8}Co_{0.1}Mn_{0.1}O₂ | TiNb₂O₇ |
| Example 21 | LiNi_{0.8}Co_{0.1}Mn_{0.1}O₂ | TiNb₂O₇ |
| Example 22 | LiNi_{0.8}Co_{0.1}Mn_{0.1}O₂ | TiNb₂O₇ |
| Comparative | LiNi_{0.8}Co_{0.1}Mn_{0.1}O₂ | TiNb₂O₇ |
| Example 1 | | |
| Comparative | LiNi_{0.8}Co_{0.1}Mn_{0.1}O₂ | TiNb₂O₇ |
| Example 2 | | |
| Comparative | LiNi_{0.8}Co_{0.1}Mn_{0.1}O₂ | TiNb₂O₇ |
| Example 3 | | |
| Comparative | LiNi_{0.5}Mn_{1.5}O₄ | TiNb₂O₇ |
| Example 4 | | |
| Comparative | LiNi_{0.8}Co_{0.1}Mn_{0.1}O₂ | TiNb₂O₇ |
| Example 5 | | |
| Comparative | LiNi_{0.8}Co_{0.1}Mn_{0.1}O₂ | TiNb₂O₇ |
| Example 6 | | |
| Comparative | LiNi_{0.8}Co_{0.1}Mn_{0.1}O₂ | TiNb₂O₇ |
| Example 7 | | |
| Comparative | LiNi_{0.8}Co_{0.1}Mn_{0.1}O₂ | TiNb₂O₇ |
| Example 8 | | |
| Comparative | LiNi_{0.8}Co_{0.1}Mn_{0.1}O₂ | TiNb₂O₇ |
| Example 9 | | |

TABLE 3

| | nonaqueous electrolyte composition | Li:organic | |
|---|---|---|---|
| | (molar fractions) | cation | FSI:TFSI |
| Example 1 | S222FSI(0.5) S222TFSI(0.1)—LiFSI(0.4) | 2:3 | 9:1 |
| Example 2 | S222FSI(0.6)—LiFSI(0.4) | 2:3 | 1:0 |
| Example 3 | S222FSI(0.4)•S222TFSI(0.1)—LiFSI(0.5) | 1:1 | 9:1 |
| Example 4 | S222FSI(0.7)•S222TFSI(0.1)—LiFSI(0.2) | 1:4 | 9:1 |
| Example 5 | S222FSI(0.44)•S222TFSI(0.16)—LiFSI(0.4) | 2:3 | 5.25:1 |
| Example 6 | S222FSI(0.408)•S222TFSI(0.192)—LiFSI(0.4) | 2:3 | 4.2:1 |
| Example 7 | S222FSI(0.44)•S222TFSI(0.16)—LiFSI(0.4) | 2:3 | 5.25:1 |
| Example 8 | S222FSI(0.44)•S222TFSI(0.16)—LiFSI(0.4) | 2:3 | 5.25:1 |
| Example 9 | S222FSI(0.44)•S222TFSI(0.16)—LiFSI(0.4) | 2:3 | 5.25:1 |
| Example 10 | S222FSI(0.432)•S222TFSI(0.168)—LiFSI(0.4) | 2:3 | 5:1 |
| Example 11 | S222FSI(0.44)•S222TFSI(0.16)—LiFSI(0.4) | 2:3 | 5.25:1 |
| Example 12 | S222FSI(0.44)•S222TFSI(0.16)—LiFSI(0.4) | 2:3 | 5.25:1 |
| Example 13 | S222FSI(0.25)• S222TFSI(0.15)—LiFSI(0.6) | 3:2 | 5.7:1 |
| Example 14 | S222FSI(0.25)•S222TFSI(0.15)—LiFSI(0.6) | 3:2 | 5.7:1 |
| Example 15 | S222FSI(0.25)•S222TFSI(0.15)—LiFSI(0.6) | 3:2 | 5.7:1 |
| Example 16 | S222FSI(0.25)•S222TFSI(0.15)—LiFSI(0.6) | 3:2 | 5.7:1 |
| Example 17 | S222FSI(0.25)•S222TFSI(0.15)—LiFSI(0.6) | 3:2 | 5.7:1 |
| Example 18 | S222FSI(0.25)•S222TFSI(0.15)—LiFSI(0.6) | 3:2 | 5.7:1 |
| | and FEC (5%) | | |
| Example 19 | S111FSI(0.44)•S111TFSI(0.16)—LiFSI(0.4) | 2:3 | 5.25:1 |

TABLE 4

| | nonaqueous electrolyte composition | | |
|---|---|---|---|
| | (molar fractions) | Li:organic cation | FSI:TFSI |
| Example 20 | S223FSI(0.44)•S223TFSI(0. 16)—LiFSI(0.4) | 2:3 | 5.25:1 |
| Example 21 | S123FSI(0.44)•S123TFSI(0.16)—LiFSI(0.4) | 2:3 | 5.25:1 |
| Example 22 | S222FSI(0.44)•S111TFSI(0.16)—LiFSI(0.4) | 2:3 | 5.25:1 |
| Comparative | S222TFSI(0.9)—LiFSI(0.1) | 1:9 | 1:9 |
| Example 1 | | | |
| Comparative | S222TFSI(0.9)—LiTFSI(0.1) | 1:9 | 0:1 |
| Example 2 | | | |
| Comparative | S222TFSI(0.8)—LiFSI(0.2) | 1:4 | 1:4 |
| Example 3 | | | |
| Comparative | S222TFSI(0.8)—LiFSI(0.2) | 1:4 | 1:4 |
| Example 4 | | | |
| Comparative | S222TFSI(0.7)—LiFSI(0.3) | 3:7 | 3:7 |
| Example 5 | | | |
| Comparative | S222TFSI(0.5)—LiFSI(0.5) | 1:1 | 1:1 |
| Example 6 | | | |
| Comparative | S222TFSI(0.2)—LiFSI(0.8) | 4:1 | 4:1 |
| Example 7 | | | |
| Comparative | EMIFSI(0.6)—LiFSI(0.4) | 2:3 | 1:0 |
| Example 8 | EMI: 1-ethyl-3-methylimidazolium | | |
| Comparative | 1.2M LiPF₆—PC/DEC(1:2) | | |
| Example 9 | | | |

TABLE 5

| | | | | Number | 1C |
|---|---|---|---|---|---|
| | Discharge | Average | | of | discharge rate |
| | capacity | voltage | Energy | cycle life | performance |
| | (Ah) | (V) | (Wh) | at 70° C. | (%) |
| Example 1 | 2 | 2.25 | 4.5 | 800 | 90 |
| Example 2 | 2 | 2.25 | 4.5 | 700 | 85 |
| Example 3 | 2 | 2.25 | 4.5 | 850 | 80 |
| Example 4 | 2 | 2.2 | 4.4 | 600 | 70 |
| Example 5 | 1.9 | 2.2 | 4.18 | 500 | 65 |
| Example 6 | 2 | 2.1 | 4.2 | 600 | 75 |
| Example 7 | 2 | 2.25 | 4.5 | 700 | 90 |
| Example 8 | 1.7 | 2.3 | 3.91 | 900 | 92 |
| Example 9 | 1.5 | 2.3 | 3.45 | 600 | 85 |
| Example 10 | 2 | 2.25 | 4.5 | 650 | 85 |
| Example 11 | 1.5 | 3.1 | 4.65 | 400 | 80 |
| Example 12 | 1.6 | 3.2 | 5.12 | 300 | 70 |
| Example 13 | 1.4 | 3.7 | 5.18 | 300 | 70 |
| Example 14 | 2 | 3.75 | 7.5 | 150 | 50 |
| Example 15 | 1.8 | 3.7 | 6.66 | 180 | 50 |
| Example 16 | 1.6 | 3.7 | 5.92 | 250 | 70 |
| Example 17 | 1.5 | 3.7 | 5.55 | 250 | 70 |
| Example 18 | 2 | 2.25 | 4.5 | 1000 | 80 |
| Example 19 | 1.9 | 2.1 | 3.99 | 400 | 60 |

TABLE 6

| | | | | | 1C |
|---|---|---|---|---|---|
| | Discharge | Average | | Number of | discharge rate |
| | capacity | voltage | Energy | cycle life | performance |
| | (Ah) | (V) | (Wh) | at 70° C. | (%) |
| Example 20 | 2.0 | 2.0 | 4.0 | 800 | 55 |
| Example 21 | 2.1 | 2.25 | 4.725 | 750 | 90 |
| Example 22 | 2.1 | 2.25 | 4.725 | 700 | 90 |
| Comparative | 1.5 | 2.1 | 3.15 | 50 | 40 |
| Example 1 | | | | | |
| Comparative | 1.0 | 2 | 2 | 10 | 20 |
| Example 2 | | | | | |
| Comparative | 1.6 | 2.1 | 3.36 | 80 | 50 |
| Example 3 | | | | | |
| Comparative | 1.4 | 3.0 | 4.2 | 10 | 30 |
| Example 4 | | | | | |
| Comparative | 1.6 | 2.1 | 3.36 | 80 | 60 |
| Example 5 | | | | | |
| Comparative | 1.5 | 2 | 3 | 100 | 50 |
| Example 6 | | | | | |
| Comparative | 1.2 | 2 | 2.4 | 80 | 10 |
| Example 7 | | | | | |
| Comparative | 1.5 | 2 | 3.0 | 50 | 40 |
| Example 8 | | | | | |
| Comparative | 2 | 2.25 | 4.5 | 80 | 70 |
| Example 9 | | | | | |

As is clear from Tables 1 to 6, the batteries of Examples 1 to 22 are excellent in high-temperature cycle life performance as compared with Comparative Examples 1 to 9. In Examples, the secondary battery is charged and discharged in the temperature range of 45° C. or more and 70° C. or less. Therefore, the operating temperature of the secondary battery is included in the range of 20° C. or more and 80° C. or less. From the results of Examples 1 to 4, it has been found that in a case where the temperature range in which the nonaqueous electrolyte is used is 20° C. or more and 80° C. or less, if the molar ratio between FSI anions and TFSI anions is 9:1 to 1:0, high-temperature cycle life performance of 600 cycles or more is obtained.

Comparison between Example 1 and Example 2 shows that the high-temperature cycle life performance and the discharge rate performance of Example 1 in which the anion components of the ionic liquid include FSI and TFSI are superior to those of Example 2.

Comparison among Examples 5, 7, and 8 shows that the high-temperature cycle life performance and the discharge rate performance of Examples 7 and 8 using the titanium-containing oxide or the titanium-niobium-containing oxide are superior to those of Example 5.

Comparison among Examples 7, 9, 11, and 12 in which the titanium-niobium-containing oxide was used as the negative electrode active material and the positive electrode active material was changed shows that the high-temperature cycle life performance and the discharge rate performance of Example 7 in which the lithium nickel cobalt manganese oxide was used as the positive electrode active material are superior to those of Examples 9, 11, and 12.

Comparison among Examples 7 and 13 to 17 in which the lithium nickel cobalt manganese oxide was used as the positive electrode active material and the negative electrode active material was changed shows that the high-temperature cycle life performance and the discharge rate performance of Example 7 in which the titanium-niobium-containing oxide was used as the negative electrode active material are superior to those of Examples 13 to 17.

With respect to the molar ratio between FSI anions and TFSI anions in the anion component of the ionic liquid, all of Comparative Examples 1 and 3 to 5 in which the amount of FSI anions is smaller than the amount of TFSI anions, Comparative Example 2 including the ionic liquid not containing the FSI anion, Comparative Example 6 in which the numbers of moles of the FSI anion and the TFSI anion are equal, and Comparative Example 7 in which the molar ratio between FSI anions and TFSI anions is 4:1 are inferior in high-temperature cycle life performance to Examples.

As shown in Comparative Example 8, in a case where the cationic component of the ionic liquid is imidazolium ions, the high-temperature cycle life performance and the discharge rate performance were inferior to those of Examples.

In Comparative Example 9, since the organic electrolytic solution was used instead of the ionic liquid, the high-temperature cycle life performance was inferior to that of Example 1.

According to the nonaqueous electrolyte of at least one embodiment or Example described above, the durability performance at a high temperature can be improved because the molar ratio between lithium ions and trialkylsulfonium ions is in the range of 1:4 to 4:1 and the molar ratio between [N(FSO₂)₂]⁻ and [N(CF₃SO₂)₂]⁻ is in the range of 4.2:1 to 1:0. In addition, since it has a high energy density, it is also suitable for stationary power supplies and space uses.

Hereinafter, the invention of the embodiment will be additionally described.

<1> A nonaqueous electrolyte comprising an ionic liquid including a cation including a trialkylsulfonium ion and a lithium ion, and an anion including at least one of [N(FSO₂)₂]⁻ or [N(CF₃SO₂)₂]⁻, wherein a molar ratio between the lithium ion and the trialkylsulfonium ion is in a range of 1:4 to 4:1, and a molar ratio between [N(FSO₂)₂]⁻ and [N(CF₃SO₂)₂]⁻ is in a range of 4.2:1 to 1:0.

<2> The nonaqueous electrolyte according to <1>, wherein the trialkylsulfonium ion is a triethylsulfonium ion.

<3> The nonaqueous electrolyte according to <1> or <2>, wherein the anion includes [N(FSO₂)₂]⁻ and [N(CF₃SO₂)₂]⁻, and a molar ratio between [N(FSO₂)₂]⁻ and [N(CF₃SO₂)₂]⁻ is in a range of 4.2:1 to 1:0 (provided that 1:0 is excluded).

<4> A secondary battery comprising:
a positive electrode capable of allowing lithium or a lithium ion to be inserted in and extracted from;
   a negative electrode capable of allowing lithium or a lithium ion to be inserted in and extracted from; and
   the nonaqueous electrolyte according to any one of <1> to <3>.

<5> The secondary battery according to <4>, wherein the positive electrode includes one or more selected from the group consisting of a lithium nickel manganese oxide having a spinel structure, a lithium cobalt oxide, a lithium nickel cobalt manganese oxide, a lithium nickel cobalt aluminum oxide, lithium cobalt phosphate, and a lithium manganese oxide.

<6> The secondary battery according to <4> or <5>, wherein the negative electrode includes one or more selected from the group consisting of lithium metal, a lithium alloy, a carbonaceous material, silicon, a silicon oxide, a titanium-containing oxide, a niobium-containing oxide, and a titanium-niobium-containing oxide.

<7> A battery pack including the secondary battery according to any one of <4> to <6>.

<8> The battery pack according to <7>, further including:
an external power distribution terminal; and
a protective circuit.

<9> The battery pack according to <7> or <8>, including a plurality of secondary battery,
wherein the secondary batteries are electrically connected in series, in parallel, or in combination of series and parallel.

<10> A vehicle including the battery pack according to any one of <7> to <9>.

<11> A stationary power supply including the battery pack according to any one of <7> to <9>.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte comprising an ionic liquid comprising a cation and an anion, the cation comprising a trialkylsulfonium ion and a lithium ion, and the anion comprising at least one of [N(FSO₂)₂]⁻ or [N(CF₃SO₂)₂]⁻, wherein a molar ratio between the lithium ion and the trialkylsulfonium ion is in a range of 1:4 to 4:1, and a molar ratio between [N(FSO₂)₂]⁻ and [N(CF₃SO₂)₂]⁻ is in a range of 4.2:1 to 1:0.

2. The nonaqueous electrolyte according to claim 1, wherein the trialkylsulfonium ion is a triethylsulfonium ion.

3. The nonaqueous electrolyte according to claim 1, wherein the anion comprises [N(FSO₂)₂]⁻ and [N(CF₃SO₂)₂]⁻, and a molar ratio between [N(FSO₂)₂]⁻ and [N(CF₃SO₂)₂]⁻ is in a range of 4.2:1 to 1:0 (provided that 1:0 is excluded).

4. The nonaqueous electrolyte according to claim 1, wherein a molar ratio between [N(FSO₂)₂]⁻ and [N(CF₃SO₂)₂]⁻ is in a range of 9:1 to 1:0.

5. The nonaqueous electrolyte according to claim 1, wherein a molar ratio between [N(FSO₂)₂]⁻ and [N(CF₃SO₂)₂]⁻ is in a range of 4.2:1 to 9:1.

6. The nonaqueous electrolyte according to claim 1, wherein a molar ratio between the lithium ion and the trialkylsulfonium ion is in a range of 1:3 to 2:1.

7. A secondary battery comprising:
a positive electrode;
a negative electrode; and
the nonaqueous electrolyte according to claim 1.

8. The secondary battery according to claim 7, wherein the positive electrode comprises one or more selected from the group consisting of a lithium nickel manganese oxide having a spinel structure, a lithium cobalt oxide, a lithium nickel cobalt manganese oxide, a lithium nickel cobalt aluminum oxide, lithium cobalt phosphate, and a lithium manganese oxide.

9. The secondary battery according to claim 8, wherein the negative electrode comprises one or more selected from the group consisting of lithium metal, a lithium alloy, a carbonaceous material, silicon, a silicon oxide, a titanium-containing oxide, a niobium-containing oxide, and a titanium-niobium-containing oxide.

10. A battery pack comprising the secondary battery according to claim 7.

11. The battery pack according to claim 10, further comprising:
an external power distribution terminal; and
a protective circuit.

12. The battery pack according to claim 10, comprising a plurality of the secondary battery,
wherein the secondary batteries are electrically connected in series, in parallel, or in a combination of series and parallel.

13. A vehicle comprising the battery pack according to claim 10.

14. A stationary power supply comprising the battery pack according to claim 10.
